(19) United States
(12) Patent Application Publication
(10) Pub. No.: US 2016/0175071 A1
(43) Pub. Date: Jun. 23, 2016

(54) ORTHODONTIC BRACKET

(71) Applicant: Metal Industries Research and Development Centre, Kaohsiung (TW)

(72) Inventor: Ming-Hui CHEN, Kaohsiung (TW)

(21) Appl. No.: 14/579,422

(22) Filed: Dec. 22, 2014

(51) Int. Cl. A61C 7/28

(52) U.S. Cl. CPC A61C 7/28

(57) ABSTRACT

An orthodontic bracket is for use with an arch wire and is for attaching to a tooth. The orthodontic bracket includes abase unit. The base unit includes a base member that has a first side for attaching to the tooth and a second side opposite to the first side, and a plurality of retaining bars that project from the second side of the base member away from the first side and that are angularly spaced apart from one another, every adjacent pair of the retaining bars defining a retaining passage that is configured to permit selective extension of the arch wire therethrough.

### FIELD OF THE INVENTION

This invention relates to an orthodontic bracket, more particularly to an orthodontic bracket with a plurality of retaining passages that permit selective extension of an arch wire therethrough.

### BACKGROUND OF THE INVENTION

Referring to FIG. 1, a plurality of conventional orthodontic brackets 1 are respectively attached to a patient's teeth and are used in conjunction with an arch wire 2 for repositioning the teeth. Each of the orthodontic brackets 1 includes a base body 11 that has a side for attaching to the corresponding tooth and an opposite side, and a retaining member 12 that is disposed at the opposite side and that is configured with a retaining slot 121. The arch wire 2 extends through the retaining slot 121 of each of the orthodontic brackets 1 and is retained therein.

In an orthodontic treatment, the front side of each tooth needs to be cleaned first, and then coated with an adhesive material for attaching a respective one of the orthodontic brackets 1. The orthodontic brackets 1 act in combination with the arch wire 2 to apply a force to slowly move the teeth, each toward a desired position. During the orthodontic treatment, regular visits to an orthodontist are required to check orthodontic progress and to adjust positions of the orthodontic brackets 1 for changing the force applied to the teeth. As such, each of the teeth is continuously moved toward the desired position.

In adjusting positions of the orthodontic brackets 1, the arch wire 2, the orthodontic brackets 1 and the adhesive material are removed in sequence, and a position or an orientation of each of the orthodontic brackets 1 is reconfirmed before application of the adhesive material and attaching the orthodontic brackets. Therefore, treatment using the conventional orthodontic brackets 1 is time consuming for each adjustment process.

### SUMMARY OF THE INVENTION

The object of the present invention is to provide an orthodontic bracket that is convenient to use and that permits quick adjustment of an arch wire.

According to the present invention, an orthodontic bracket is for use with an arch wire and is for attaching to a tooth. The orthodontic bracket includes a base unit including abase member that has a first side for attaching to the tooth, and a second side opposite to the first side, and a plurality of retaining bars projecting from the second side of the base member away from the first side and being spaced apart from one another. Every adjacent pair of the retaining bars defines a retaining passage that is configured to permit selective extension of the arch wire therethrough.

### BRIEF DESCRIPTION OF THE DRAWINGS

Other features and advantages of the present invention will become apparent in the following detailed description of the embodiments of this invention, with reference to the accompanying drawings, of which:

FIG. 1 is a schematic front view showing an arch wire received in retaining slots of two conventional orthodontic brackets;

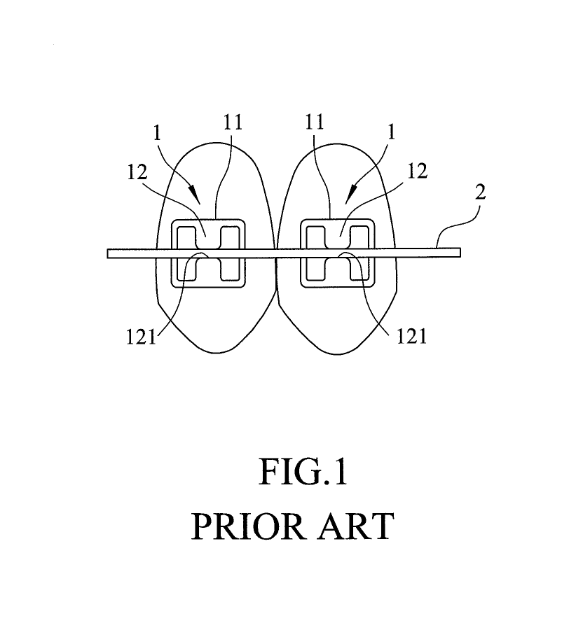

FIG. 2 is an exploded perspective view of a first embodiment of an orthodontic bracket according to the present invention, illustrating a cover unit disconnected from a base member;

FIG. 3 is a side view of the first embodiment, illustrating the cover unit connected to the base member;

FIG. 4A and FIG. 4B are front views showing selective extension of the arch wire through a plurality of retaining passages of the first embodiment;

FIG. 5 is an exploded perspective view of a second embodiment of the present invention;

FIG. 6 is a schematic front view showing two elastic bands used cooperatively with two of the orthodontic brackets of the second embodiments; and

FIG. 7 is an exploded perspective view of a third embodiment of the present invention.

### DETAILED DESCRIPTION OF THE EMBODIMENTS

Before the present invention is described in greater detail with reference to the accompanying embodiments, it should be noted herein that like elements are denoted by the same reference numerals throughout the disclosure.

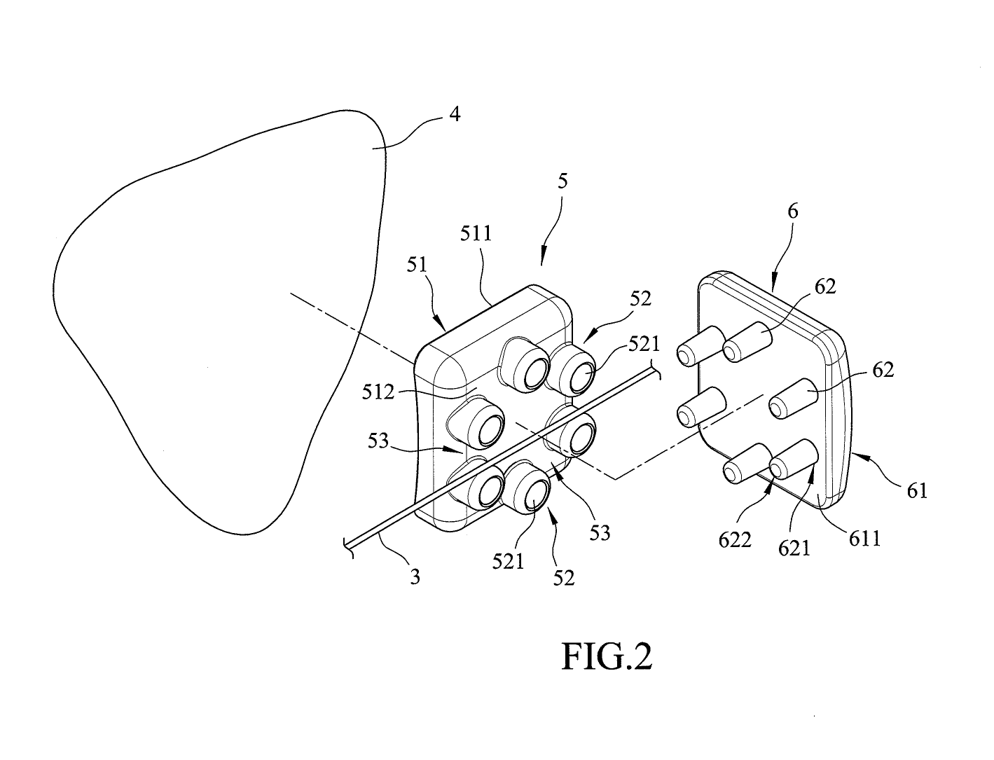

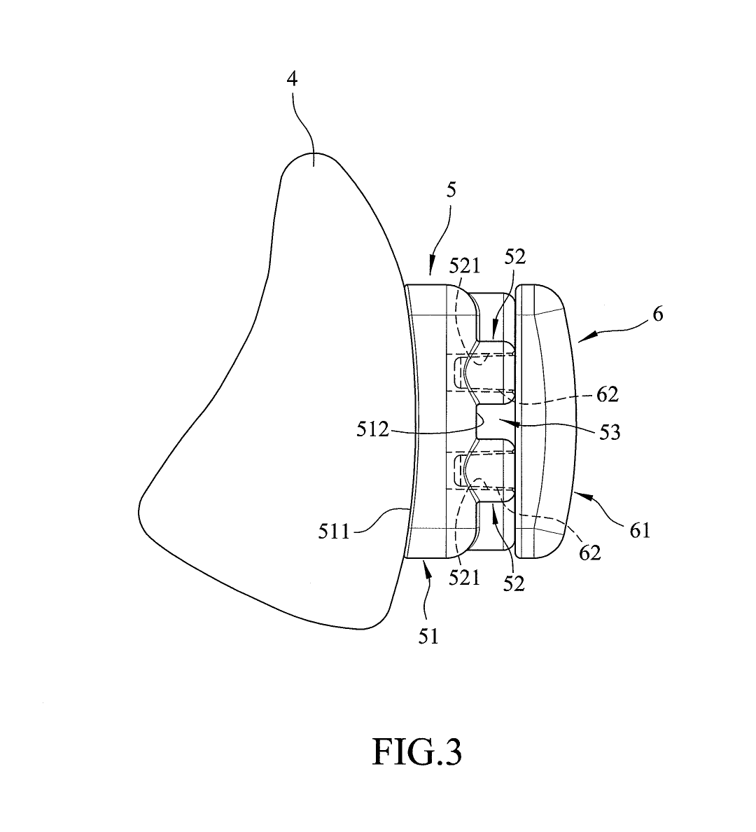

Referring to FIGS. 2 and 3, a first embodiment of an orthodontic bracket according to the present invention is to be used with an arch wire 3 and is to be attached to a tooth 4. The orthodontic bracket includes a base unit 5 and a cover unit 6. The base unit 5 is made of metal, and the cover unit 6 is made of plastic that is consumable.

The base unit 5 includes a base member 51 and a plurality of retaining bars 52. The base member 51 has a first side 511 for attaching to the tooth 4 and a second side 512 opposite to the first side 511. The retaining bars 52 project from the second side 512 of the base member 51 away from the first side 511 and are spaced apart from one another. Every adjacent pair of the retaining bars 52 defines a retaining passage 53 that is configured to permit selective extension of the arch wire 3 therethrough such that extension of the arch wire 3 is adjustable relative to the base unit 5. The retaining bars 52 cooperate to define at least two of the retaining passages 53. To be more specific, the retaining bars 52 cooperate to define more than two of the retaining passages 53. Each of the retaining bars 52 has an engaging portion 521. In the first embodiment, the base unit 5 includes six of the retaining bars 52. The retaining bars 52 are angularly arranged in a circular formation and cooperate with one another to define six of the retaining passages 53. The engaging portion 521 of each of the retaining bars 52 is a blind hole. It should be noted that as long as the extension of the arch wire 3 in the retaining passages 53 is adjustable, the number of the retaining bars 52 is not limited to six and may vary based on actual requirements.

The cover unit 6 includes a cover member 61 that is spaced apart from the base member 51 and that has a covering side 611 disposed to face the second side 512 of the base member 51, and a plurality of connecting members 62 that project from the covering side 611 of the cover member 61 toward the second side 512 of the base member 51 and that are spaced apart from one another. Each of the connecting members 62 is releasably connected to a corresponding one of the retaining bars 52, and has a first end portion 621 proximate to the covering side 611 of the cover member 61, and a second end portion 622 that is opposite to the first end portion 621. Each of the connecting members 62 has a cross-section that is gradually reduced from the first end portion 621 to the second end portion 622 such that each of the connecting members 62 may easily engage a respective one of the engaging portions 521 of the retaining bars 52. In the first embodiment, the cover unit 6 includes six of the connecting members 62, and each of the connecting members 62 is frustoconical in shape so as to fittingly engage the respective one of the engaging portions 521 of the retaining bars 52. This configuration allows the cover unit 6 to be connected to the base unit 5 to retain the arch wire 3 between the cover unit 6 and the base member 51 of the base unit 5.

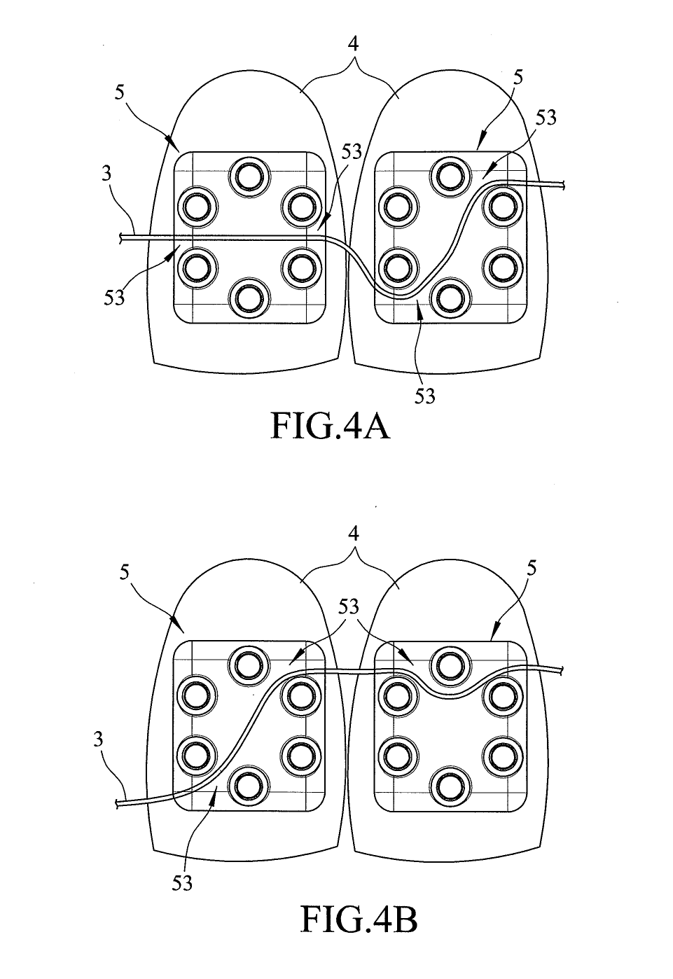

Referring to FIG. 2, after removing the cover unit 6, the extension of the arch wire 3 is adjustable (see FIG. 4A and FIG. 4B) by selectively extending through specific ones of the retaining passages 53 based on actual adjusting needs. As such, a force applied to the teeth 4 is readjusted. After adjustment, the cover unit 6 is connected back to the base unit 5 (see FIG. 3). The retaining bars 52 and the retaining passages 53 are configured such that the orthodontic bracket does not have to be removed from the teeth 4 for each adjustment process Therefore, the adjustment process is simplified and takes up less time.

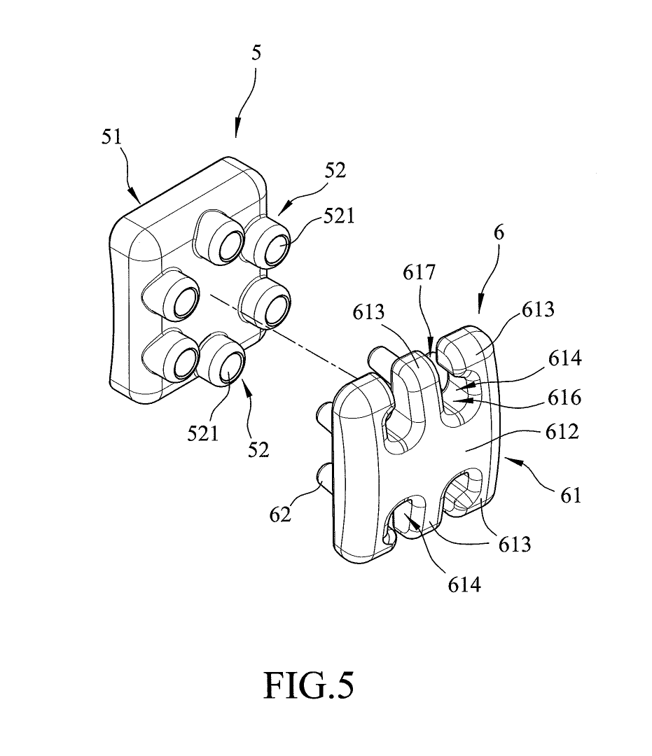

Referring to FIG. 5, a second embodiment of the present invention differs from the first embodiment in that the cover member 61 of the cover unit 6 has a trunk portion 612 that has upper and lower edges, and a plurality of branch portions 613 that extend from the upper and lower edges of the trunk portion 612 and that are spaced apart from one another. Adjacent ones of the branch portions 613 define a plurality of spaces 614, each of which has a first space portion 616 that is proximate to the trunk portion 612, and a second space portion 617 that is away from the trunk portion 612 and that has a width smaller than that of the first space portion 616. In the second embodiment, the cover member 61 has six of the branch portions 613 that extend from the upper and lower edges of the trunk portion 612.

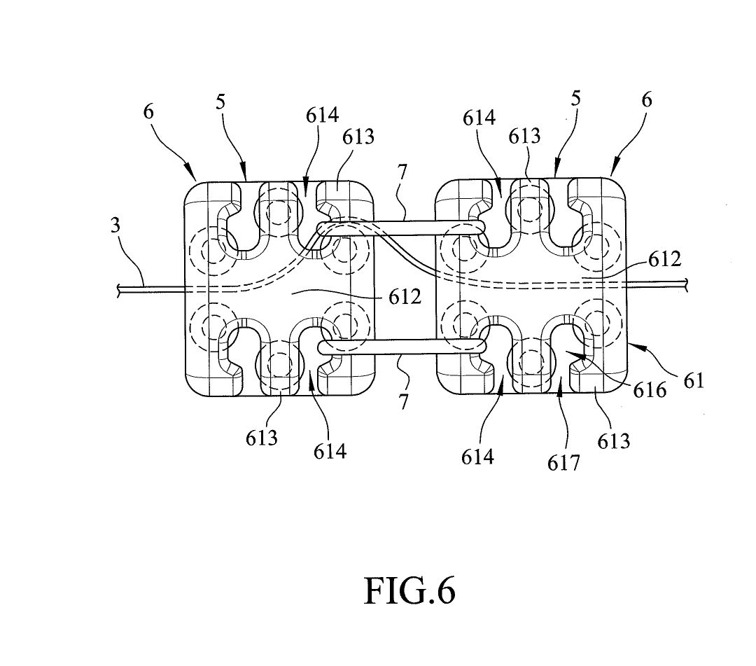

Referring to FIG. 6, when using two orthodontic brackets of the second embodiment, the orthodontic brackets may be linked together by two elastic bands 7. Each of the elastic bands 7 has two opposite end portions, one of which is received in the first space portion 616 of one of the cover members 61, and the other one of which is received in the first space portion 616 of the other one of the cover members 61. Since the width of the second space portion 617 is smaller than that of the first space portion 616 of each of the cover members 61, the elastic bands 7 are securely positioned between two adjacent ones of the branch portions 613. The elastic bands 7 may assist the arch wire 3 to adjust the force applied to the teeth 4.

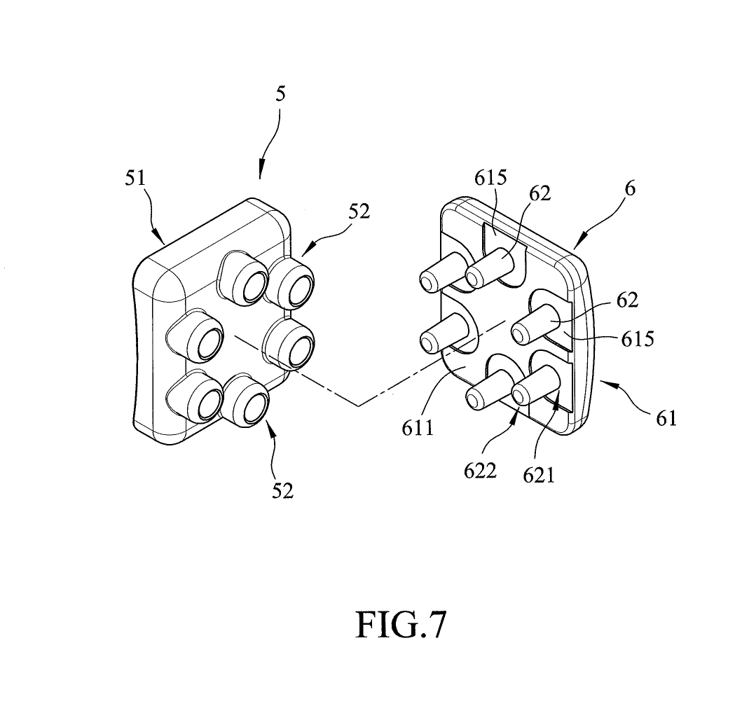

Referring to FIG. 7, a third embodiment of the present invention differs from the first embodiment in that the cover member 61 further has six of spaced-apart grooves 615 each formed in the covering side 611 of the cover member 61 for extension of a respective one of the retaining bars 52 therein such that wobbling of the cover unit 6 with respect to the base unit 5 may be arrested.

To sum up, extension of the arch wire 3 is adjustable by selectively extending through the retaining passages 53 to re-adjust the force applied to the teeth 4 without requiring adjustment of the orthodontic bracket, thereby increasing convenience in use and decreasing time taken for each adjustment process. The elastic bands 7 may assist the arch wire 3 to adjust the force applied to the teeth 4. The grooves 615 are configured to prevent wobbling of the cover unit 6 with respect to the base unit 5 such that the cover unit 6 is more stably connected to the base unit 5.

While the present invention has been described in connection with what are considered the most practical embodiments, it is understood that this invention is not limited to the disclosed embodiments but is intended to cover various arrangements included within the spirit and scope of the broadest interpretation and equivalent arrangements.

What is claimed is:

1. An orthodontic bracket for use with an arch wire and for attaching to a tooth, said orthodontic bracket comprising:
a base unit including
a base member that has a first side for attaching to the tooth and a second side opposite to said first side, and
a plurality of retaining bars that project from said second side of said base member away from said first side and that are spaced apart from one another, every adjacent pair of said retaining bars defining a retaining passage that is configured to permit selective extension of the arch wire therethrough.

2. The orthodontic bracket as claimed in claim 1, further comprising a cover unit that is releasably connected to said base unit for retaining the arch wire between said cover unit and said base member.

3. The orthodontic bracket as claimed in claim 2, wherein said cover unit is releasably connected to at least one of said retaining bars.

4. The orthodontic bracket as claimed in claim 2, wherein said cover unit includes a cover member that is spaced apart from said base member and that has a covering side disposed to face said second side of said base member, and a plurality of connecting members that project from said covering side of said cover member toward said second side of said base member and that are spaced apart from one another, each of said connecting members being releasably connected to a corresponding one of said retaining bars.

5. The orthodontic bracket as claimed in claim 4, wherein each of said retaining bars has an engaging portion for fittingly engaging a corresponding one of said connecting members.

6. The orthodontic bracket as claimed in claim 5, wherein each of said connecting members has a first end portion proximate to said covering side of said cover member, and a second end portion that is opposite to said first end portion, each of said connecting members having a cross-section that is gradually reduced from said first end portion to said second end portion.

7. The orthodontic bracket as claimed in claim 6, wherein each of said connecting members is frustoconical in shape.

8. The orthodontic bracket as claimed in claim 7, wherein said engaging portion of each of said retaining bars is a blind hole.

9. The orthodontic bracket as claimed in claim 5, wherein said cover member further has a plurality of spaced-apart grooves each formed in said covering side of said cover member for extension of a corresponding one of said retaining bars therein.

10. The orthodontic bracket as claimed in claim 2, wherein said cover unit includes a cover member that has a trunk portion and a plurality of branch portions that extend from said trunk portion and that are spaced apart from one another.

11. The orthodontic bracket as claimed in claim 10, wherein said trunk portion has upper and lower edges from which said branch portions extend.

12. The orthodontic bracket as claimed in claim 11, wherein adjacent ones of said branch portions define a plurality of spaces, each of which has a first space portion that is proximate to said trunk portion and a second space portion that is away from said trunk portion and that has a width smaller than that of said first space portion.

13. The orthodontic bracket as claimed in claim 1, wherein said retaining bars are angularly arranged in a circular formation.

14. The orthodontic bracket as claimed in claim 13, wherein said base unit includes six of said retaining bars.

15. The orthodontic bracket as claimed in claim 1, wherein said base unit is made of metal.

16. The orthodontic bracket as claimed in claim 1, wherein said cover unit is made of plastic.

17. The orthodontic bracket as claimed in claim 2, wherein said cover unit includes a cover member that has a trunk portion and a branch portion that extends from one edge of said trunk portion.

18. The orthodontic bracket as claimed in claim 1, wherein said retaining bars cooperate to define at least two of said retaining passages.

19. The orthodontic bracket as claimed in claim 18, wherein said retaining bars cooperate to define more than two of said retaining passages.
